(19) United States
(12) Patent Application Publication
(10) Pub. No.: US 2011/0236708 A1
(43) Pub. Date: Sep. 29, 2011

(54) Polyolefin Construction

(75) Inventors: Harry Oysaed, Stathelle (NO); Markus Gahleitner, Neuhofen/Krems (AT); Karl Isak Skau, Langesund (NO); Geir Morton Johansen, Porsgrunn (NO)

(73) Assignee: Borealis AG, Vienna (AT)

(21) Appl. No.: 13/120,385

(22) PCT Filed: Sep. 22, 2009
(86) PCT No.: PCT/EP09/06824

§ 371 Date: Jun. 10, 2011

(30) Foreign Application Priority Data
Sep. 23, 2008 (EP) 08164881.8

(51) Int. Cl. B32B 27/08; B32B 27/00; B29C 49/08; B29C 49/22

(52) U.S. Cl. 428/516; 428/500; 264/537; 264/513

(57) ABSTRACT

A polyolefin construction comprising at least one polyolefin (PO) layer, a barrier layer for the polyolefin layer and a compatibiliser for the PO and the barrier layer, which compatibiliser enables the PO and barrier layer to adhere together, whereby the barrier layer comprises the compatibiliser; a blended barrier layer polymer and the barrier layer formed therefrom and a process for producing the polyolefin construction.

### FIELD OF THE INVENTION

The present invention concerns a polyolefin (PO) construction including a barrier layer; a process for making the PO construction; a blended barrier layer polymer and the barrier layer formed therefrom; and products, especially containers, for example medical, and food and drink containers, made from and comprising the PO construction.

### DESCRIPTION OF THE BACKGROUND ART

Plastic based packaging, for example medical packaging or food and drink packaging, can be made of polyolefins.

Polyolefins such as polypropylene provide excellent heat resistance and are readily mouldable to provide rigid containers offering good impact resistance. These materials also provide excellent water and water vapour resistance, preventing moisture uptake of packaged goods.

A drawback of PO packaging however, is that it provides limited protection against oxygen, carbon dioxide, liquid and volatile hydrocarbon permeation, which in turn can lead to rapid deterioration of perishable products, such as medicine and food and drink products contained therein.

This problem is normally overcome by providing PO constructions with additional barrier layers—usually constructed of other polymers—which provide a barrier function against oxygen, carbon dioxide, liquid and volatile hydrocarbon permeation.

However, since these other polymers—typical examples are EVOH (ethylene vinyl alcohol copolymer) and PA (polyamide-Nylon)—are much more polar than PO, the layers lack compatibility and extra adhesive layers are required to adhere the PO and the barrier layers.

Accordingly in order to provide suitable PO packaging, a number of PO layers and barrier layers have to be adhered together, by application of further, separate adhesive layers.

For example if both outer surfaces of a final construction need to be PO—as is the case for food or medical packaging—this means that the final construction including a barrier layer has at least 5 separate layers (PO/adhesive/barrier/adhesive/PO).

The adhesives used in these multilayer systems are normally PO grafted with polar monomers such as acrylic acid or maleic anhydride.

However such packaging is susceptible to flow instability during processing—leading to product instability—and to delamination in the final product.

Furthermore such multi-layered constructions are unsuitable for injection moulding and processes involving an injection moulding step like injection stretch blow moulding (ISBM).

Three layer constructions are known from JP 2004082499 A2, EP 115163 and WO 00/63085. Specifically, WO 00/63085 describes three layer constructions consisting of two skin layers comprising polypropylene and a minor amount of a compatibiliser and/or adhesive, and a core layer of a polar polymer having good oxygen barrier properties. While providing acceptable oxygen barrier, these constructions suffer from a major drawback in that the layers do not adhere well to each other, resulting in delamination and instability of the resulting packaging system.

An alternative construction retaining the simplicity of a three layer system and the good oxygen barrier but overcoming the delamination problem was therefore sought.

### DESCRIPTION OF THE INVENTION

According to a first aspect, the invention provides a PO construction comprising at least one PO layer and a barrier layer adjacent to the PO layer, and a compatibiliser for the PO and barrier layer, which compatibiliser enables the PO and barrier layer to adhere together, whereby the barrier layer comprises the compatibiliser.

As such, separate adhesive layers are not required for this at least two-layer containing construction.

The compatibiliser is blended with the barrier layer polymer to form an adhesive/barrier mixture. Accordingly, the compatibiliser is preferably blendable with the barrier layer polymer.

Blending of the compatibiliser with the barrier layer polymer enables a reduction in the number of layers of the PO construction.

The barrier layer preferably forms a barrier against oxygen (O₂), carbon dioxide (CO₂), liquid or volatile hydrocarbons (HC) and can comprise polar polymers like polyamide (PA), poly(vinyl alcohol) copolymers (PVOH) or ethylene vinyl alcohol copolymers (EVOH) or blends thereof. The PO layer forms a barrier against water in liquid or vapour form (H₂O) and can comprise polyolefins like polyethylene (PE) or polypropylene (PP).

More specifically, the polymer forming the barrier layer can be selected from crystalline or amorphous polyamides of aliphatic or aromatic nature like polyamide-6 (PA-6), polyamide-6-6 (PA-66), polyamide-12 (PA-12), poly-m-xylylene adipamide (nylon MXD6) or poly-m-xylylene pimelamide (nylon MXD7), or from poly(vinyl alcohol) copolymers (PVOH) or ethylene vinyl alcohol copolymers (EVOH) or blends thereof.

Even more specifically, the barrier layer can be selected from poly-m-xylylene adipamide (MXD-6; commercially available from Mitsubishi Petrochemical, Japan) and an ethylene vinyl alcohol copolymer comprising 32 wt % ethylene (EVAL F101A, commercially available from EVAL Europe, Belgium).

The polymer forming the PO layer can preferably be selected from crystalline polyolefins like high density polyethylene (HDPE), linear low density polyethylene (LLDPE) or polypropylene homo- or copolymers (PP).

The polypropylene or polyethylene polymer of use in this invention may be unimodal or multimodal. In a unimodal polymer its molecular weight profile comprises a single peak. By multimodal, preferably bimodal, is meant that its molecular weight profile does not comprise a single peak but instead comprises the combination of two or more peaks (which may or may not be distinguishable) centred about different average molecular weights as a result of the fact that the polymer comprises two or more separately produced components, e.g. blended components or more preferably components prepared in situ.

Multimodal polymers may be prepared by simple blending, by two or more stage polymerisation or by the use of two or more different polymerisation catalysts in a one stage polymerisation. Preferably however they are produced in a two-stage polymerisation using the same catalyst, e.g. a metallocene catalyst or preferably a Ziegler-Natta catalyst, in particular a slurry polymerisation in a loop reactor followed by a gas phase polymerisation in a gas phase reactor. Conventional cocatalysts, supports/carriers, electron donors etc. can be used.

Preferred processes are the Borstar® PP and Borstar® PE process of Borealis.

Unimodal polymers can be made using a one stage process e.g. using the parameters above for slurry and gas phase processes. Catalysts employable are the same as those utilised to manufacture multimodal polymers.

Especially preferred are polypropylene homopolymers or random copolymers with ethylene or C₄-C₈ alpha-olefins having a comonomer content of 8% by weight or less.

Random copolymers of propylene and propylene homopolymers of use in this invention are commercially available from various suppliers, e.g. Borealis Polyolefine GmbH, Austria.

Even more preferred are ethylene-propylene random copolymers having a comonomer content of 1.5 to 6% by weight and a melt flow rate (MFR; 230° C./2.16 kg) of 1 to 100, preferably 2 to 50 g/10 min. An especially preferred example is RF926MO (MFR; 230° C./2.16 kg: 20 g/10 min; commercially available from Borealis Polyolefine GmbH, Austria).

The polyolefin may also be mixed with minor amounts known to an art skilled person of standard polymer additives such as polymer processing agent, nucleating agents, antioxidants, reheat agents, UV stabilisers, clarifying agents etc.

The compatibiliser can comprise an acid or anhydride modified polyolefin, for example anhydride-modified polypropylene or polyethylene resin; or styrene block copolymers.

Preferred are maleic anhydride grafted polypropylene or polyethylene homo- or copolymers and maleic anhydride grafted and/or hydrogenated styrene block copolymers having a melt flow rate MFR₂ of 1 to 100, preferably 2 to 50 g/10 min.

The anhydride content of the maleic anhydride grafted polymers is 0.1 to 10, preferably 0.2 to 8 wt %.

Suitable maleic anhydride grafted polypropylene or polyethylene homo- or copolymers and maleic anhydride grafted and/or hydrogenated styrene block copolymers are also commercially available.

Especially preferred examples are:
maleic anhydride modified polypropylenes like Bynel 50E725 (commercially available from DuPont de Nemours Inc., USA), Scona TPPP 2112GA (commercially available from Kometra GmbH, Germany) or Polybond 3200 (commercially available from Crompton SA, Belgium)
maleic anhydride modified polyethylenes like Bynel 41E687 (commercially available from DuPont de Nemours Inc., USA),
grafted and ungrafted styrene block copolymers, like styrene-butadiene di- and triblock copolymers, either in native or in hydrogenated form. Tri-block copolymers include styrene elastomers, more specifically styrene-ethylene-butene-styrene terpolymers (SEBS), styrene-ethylene-propylene-styrene terpolymers (SEPS) and styrene-isoprene-styrene terpolymers (SIS), which can be additionally modified by grafting with minor amounts of an acid or anhydride component. Preferred examples are the non-grafted, hydrogenated SEBS Tuftec H1221 (commercially available from Asahi Denka, Japan) and the maleic anhydride grafted SEBS Kraton FG 1901X (commercially available from Kraton Inc., UK).

The compatibiliser is blended with the barrier layer polymer so that the total weight of the compatibiliser lies in the range of 0.1-20 wt %., preferably 0.5-15 wt %., and more preferably is at the most 10 wt %. of the barrier layer forming polymer.

The blend mixture comprising a barrier layer forming polymer as described above and a compatibiliser in an amount of 0.1-20 wt %., preferably 0.5-15 wt %., and more preferably is at the most 10 wt % of the barrier layer forming polymer, and the barrier layer formed of this mixture are further aspects of the present invention.

Preferably the blend mixture comprises EVOH as barrier layer forming polymer and a compatibiliser selected from maleic anhydride grafted polypropylene homo- or copolymers having a melt flow rate (MFR; 230° C./2.16 kg) of 1 to 100, preferably 2 to 50 g/10 min and an anhydride content of 0.1 to 10, preferably 0.2 to 8 wt %., non-grafted, hydrogenated or maleic anhydride grafted styrene-ethylene-butene-styrene terpolymers.

The compositions for the PO layer and the barrier layer can be produced by any suitable melt mixing process at temperatures above the melting point of the respective polyolefin or barrier polymer composition.

Typical devices for performing said melt mixing process are twin screw extruders, single screw extruders optionally combined with static mixers, chamber kneaders such as Farell kneaders and reciprocating co-kneaders, for example Buss co-kneaders.

Preferably, the melt mixing process is carried out in a twin screw extruder with high intensity mixing segments and preferably at a temperature of 20-50° C. above the melting point of the respective base polymer, but below the stability limit temperature of the barrier polymer.

A good adhesion between the barrier and the PO layer reduces the chances of delamination in the final product, enhancing mechanical stability and lifetime of the produced container.

The PO construction according to the invention preferably has an adhesion force between the barrier layer and the PO layer of up to 20 N, and is preferably >3N, more preferably >5N and even more preferably >8N.

In case the PO construction comprises more than one PO layer, that adhesion force is present between the barrier layer and any PO layers directly in contact with the same.

A preferred embodiment of the PO construction according to the present invention consists of a single PO layer, and a single barrier layer blended with the compatibiliser.

A further preferred embodiment of the PO construction according to the present invention consists of a single barrier layer blended with the compatibiliser, sandwiched between two PO layers.

Since these embodiments consist of two and three layers respectively, they are particularly suitable to cast film extrusion techniques followed by uni- or biaxially stretching techniques and to injection and blow moulding techniques, especially for injection stretch blow moulding (ISBM).

Preferably the PO construction have a thickness of 500 to 3000 μm before, and 100 to 1000 μm after stretching at a stretching ratio of 1.5 to 10 whereby the relative barrier layer thickness preferably lies between 5 to 50%, more preferably 10 to 40% of the overall PO construction thickness.

The ISBM process is well known in the art and involves producing a pre-form by injection moulding followed by stretching and blowing the pre-form in order to induce biaxial orientation in the solid phase. Two types of ISBM process are practised. In the single-stage process a pre-form is injection moulded, stretched and blown before it is allowed to cool. In the two-stage process, the injection moulded pre-form is allowed to cool before it is reheated, stretched and blown into a container. Since the PO and the barrier polymer typically have different melting temperatures the processing window of the materials might not overlap or may overlap to a limited extent.

The processing window for the ISBM process is measured by an ISBM simulation test, as described for example in EP 1 950 028. In the ISBM simulation test, the processing window is that for biaxial stretching of injection moulded plaques or cast films and is defined as the difference between the Max. temp and Min. temp wherein:

Max. temp=the temperature at which a maximum stretching force of 10N is required to stretch the polymer (at maximum stretching force less than 10N, areas of melted polymer are visible on the sample)
Min. temp=the lowest temperature at which stretching of the polymer is possible without polymer failure.

The test is described in the Examples and is carried out as follows for injection moulded plaques. Boxes of 35 cm×15 cm×10 cm, with a thickness of 2 mm are injection moulded at Netstal 1570/300 MPS injection moulding machine at 230 deg. C. with an injection speed of 100 mm/s, a holding pressure to 315 grams product weight of box and a holding time of 12 s. Dosing at backpressure of 100 bar and 150 rpm. The mould temperature is 30 deg. C. on injection side and 15 deg. C. on clamping side. The cooling time is 15 s. For the examples and comparative examples involving a three-layer structure a sequence of first injecting the polyolefin (polypropylene) layers and then injecting the barrier layer forming polymer or polymer composition suitable to generate a middle layer having a thickness of about 300 μm or 15% of the overall thickness is chosen.

From the bottom of these boxes plaques of about 86 mm×86 mm×2 mm are cut for biaxial drawing in a laboratory film stretcher KARO IV (Brückner Maschinenbau GmbH, Siegsdorf, Germany).

The plaques are heated in a heating chamber by IR radiation, for 120 s before drawing. The stretch speed is 35 m/min. with a stretch ratio of 3.5×3.5 to achieve a thickness reduction of 10× (e.g. from 2 mm to 0.2 mm). During biaxial drawing the stretching force as a function of time is recorded.

The temperature range over which the sample can be stretched without producing visible failures is the processing window. Temperatures that are too low for stretching cause polymer failure. Temperatures that are too high for stretching cause the polymer to melt and/or lead to visible variations in the thickness of the blown articles.

Injection stretch blow moulding (ISBM) is a known process which involves certain steps. First, a 2-layer or 3-layer pre-form is injection moulded by the co-injection of the PO layer forming polyolefin composition and a composition containing the blend of barrier layer forming polymer and compatibiliser. Co-injection nozzles suitable for the preparation of 2- or 3-layer pre-forms are known in the art. In a 3-layer construction the barrier material will form the core layer in the pre-form with, typically identical, PO layers external on the pre-form.

The compositions are heated to melt them to form a flowable polymer melt that is introduced by injection into the mould. The injection mould has a cavity and a mating ram to form the pre-form into the desired shape, e.g. one having threaded neck portion and a bottle body portion. The pre-form can then be removed from the mould, cooled and stored until it is ready to be formed into an article or the pre-form can be stretched and blown straight away.

In the reheating operation, when the pre-form reaches the desired temperature, the reheated pre-form is then ready for stretch blow moulding. The pre-form is placed within a suitably shaped mould and a gas, such as air or nitrogen, is injected into the internal volume of the pre-form through a nozzle as a push rod forces the polypropylene composition to expand outwardly to fill the mould. This is the stretching and blowing stage of the process. During this step the material becomes biaxially oriented which improves the physical and optical properties of the article, as well as improving the barrier properties.

The stretching temperatures used are normally between 90 deg. C. and 160 deg. C., e.g. 130 deg. C. Stretching speeds may range from 20 to 60 m/min in both TD and MD.

Preferably the PO construction has a thickness of 500 to 3000 μm before, and 100 to 1000 μm after stretching at a stretching ratio of 1.5 to 10 whereby the relative barrier layer thickness preferably lies between 5 to 30% of the overall PO construction thickness.

Viewed from another aspect the invention provides a process for the formation of a PO construction or an article comprising:

(I) mixing a compatibiliser with a barrier layer forming polymer, e.g. EVOH or Nylon, and extruding the resulting mixture;
(II) co-injecting the extrudate from step (I) and a PO composition, to form a 2- or a 3-layer pre-form, in which 3-layer pre-form the barrier layer composition forms a core layer and the PO composition forms the outer layers;
(III) allowing the pre-form to cool;
(IV) reheating the pre-form to a temperature in the range 90 to 160 deg. C.; and
(V) stretching and blowing the pre-form to form an article.

Viewed from another aspect the invention provides a process for the formation of an article comprising:

(I) mixing a compatibiliser with a barrier layer polymer, e.g. EVOH or Nylon, and extruding the resulting mixture;
(II) co-injecting the extrudate from step (I) and a PO composition, to form a 2- or a 3-layer pre-form, in which 3-layer pre-form the barrier layer composition forms a core layer and the PO composition forms the outer layers;
and
(III) stretching and blowing the pre-form to form an article without allowing the to cool.

Further aspects of the present invention include an at least two layer article comprising

(I) a first layer comprising a random polypropylene copolymer
(II) a second layer comprising an barrier layer forming polymer blended with a compatibiliser;
and
(III) optionally a third layer comprising a random polypropylene copolymer.

The PO constructions can be advantageously used for the production of articles, especially containers as for medical uses or for food and drink packaging. They posses an advantageously high adhesion force between the PO layers and the barrier layer and further advantageously low oxygen permeability.

### EXAMPLES

A number of PO constructions according to the present invention were made and characterized.

The following components were used to prepare the examples:
EVAL F101 is an ethylene vinyl alcohol copolymer having an ethylene content of 32 mol %, a melt flow rate (190° C./2.16 kg) of 1.6 g/10 min and a density of 1190 kg/m³. The barrier polymer is commercially available from EVAL Europe NV, Belgium.

RF926MO is a propylene-ethylene random copolymer having an ethylene content of 2.6 wt %, a melt flow rate (230° C./2.16 kg) of 20 g/10 min and a density of 905 kg/m³. The polyolefin is commercially available from Borealis Polyolefine GmbH, Austria.
Bynel 50E725 is a maleic anhydride grafted polypropylene (commercially available from DuPont de Nemours Inc., USA).
Bynel 41E687 is a maleic anhydride grafted polyethylene (commercially available from DuPont de Nemours Inc., USA).
Tuftec H1221 is a hydrogenated SEBS triblock copolymer (commercially available from Asahi Denka, Japan).

All polymer mixtures were prepared on a PRISM TSE24 co-rotating twin screw extruder with a screw diameter of 24 mm and a length to diameter ratio of 40 with two high intensity mixing segments at a mixing temperature of 190-230° C. and a throughput of 10 kg/h and a screw speed of 50 rpm. The material was extruded to two circular dies of 3 mm diameter into a water bath for strand solidification and then pelletized and dried.

Injection moulded plaques were prepared by injection moulding boxes of 35 cm×15 cm×10 cm, with a thickness of 2 mm at Netstal 1570/300 MPS injection moulding machine at 230 deg. C. with an injection speed of 100 mm/s, a holding pressure to 315 grams product weight of box and a holding time of 12 s. Dosing at backpressure of 100 bar and 150 rpm. The mould temperature was 30 deg. C. on injection side and 15 deg. C. on clamping side. The cooling time was 15 s. From the bottom of these boxes, plaques of about 86 mm×86 mm×2 mm were cut for biaxial drawing.

Biaxial oriented samples were formed from injection moulded plaques prepared by the technique above. The biaxial orientation process involved biaxial drawing in a laboratory film stretcher KARO IV (Brückner Maschinenbau GmbH, Siegsdorf, Germany) at VTT, Tampere, Finland. The plaques were heated in a heating chamber by IR radiation, for a defined period of time 120 s before drawing. To simulate as much as possible the ISBM process, the maximum stretch speed of 35 m/min was used. The stretch ratio of 3.5×3.5 was selected in order to achieve a 10 times thickness reduction, e.g. from 2 mm to 0.2 mm (same as in ISBM process). During the simultaneous drawing, force elongation curves were recorded in the machine direction and in the transverse direction.

Table 1 below describes the PO constructions tested for the examples. For examples 1 to 3, the modifier (compatibiliser) was blended in a relative concentration of 10 wt % into the barrier layer according to the inventive concept, and combined with the unmodified PO layer. For comparative example 1, an unmodified barrier layer was combined with the unmodified PO layer, while for comparative example 2 and 3 the unmodified barrier layer was combined with a PO layer containing 10 wt % of a compatibiliser. Comparative example 4 is a pure PO monolayer.

TABLE 1
Layer construction for examples and comparative examples (* - MFR in g/10 min
determined at 230° C. and 2.16 kg; barrier layer thickness 15% or 30 μm in stretched form)

| EX/CE | Barrier polymer | Modifier (10%) | MFR barrier* | PO layer | Modifier (10%) | MFR PO* |
|---|---|---|---|---|---|---|
| EX 1 | EVAL F101A | Bynel 50E725 | 3.1 | RF926MO | none | 20 |
| EX 2 | EVAL F101A | Bynel 41E689 | 3.2 | RF926MO | none | 20 |
| EX 3 | EVAL F101A | Tuftec H1221 | 3.3 | RF926MO | none | 20 |
| CE 1 | EVAL F101A | none | 3.2 | RF926MO | none | 20 |
| CE 2 | EVAL F101A | none | 3.2 | RF926MO | Bynel41E689 | 18 |
| CE 3 | EVAL F101A | none | 3.2 | RF926MO | Bynel50E725 | 17 |
| CE 4 | none | none | — | RF926MO | none | 20 |

Table 2 summarizes characterization results obtained on PO constructions as described in table 1 above. All three-layer constructions have significantly lower oxygen permeability than the PO monolayer of comparative example 4.

All three-layer constructions according to the invention show improved adhesion force.

TABLE 2
Adhesion force and Oxygen permeability for
examples and comparative example

| | Adhesion force | O² permeability |
|---|---|---|
| EX/CE | N | cm³/m²day |
| EX 1 | 14 | 3.9 |
| EX 2 | 10 | 6.2 |
| EX 3 | 10 | n.d. |
| CE 1 | 3 | 10.2 |
| CE 2 | 0 | 7.8 |
| CE 3 | 3 | n.d. |
| CE 4 | — | 366 |

(n.d.—not determined)

In detail, the components and the resulting PO constructions were characterized as follows:
The melt flow rate (MFR) is an indication of the melt viscosity of the polymer. The MFR is determined at 190° C. for PE and at 230° C. for PP. The load under which the melt flow rate is determined is usually indicated as a subscript, for instance MFR₂ is measured under 2.16 kg load, MFR₅ is measured under 5 kg load or MFR₂₁ is measured under 21.6 kg. The melt flow rate (MFR) was determined according to ISO 1133 and is indicated in g/10 min.
The adhesive force between barrier and PO layers was determined on the same specimens as used for haze after forced removal of one PO layer with the T-Peel Test according to ASTM D 1876-01 using Zwick 1445 tensile tester.

The oxygen permeability was determined on 200 μm films prepared by biaxial stretching from the injection molded plates. The oxygen permeability of the film was measured at +23° C. and a relative humidity of 65% using the procedure and instrument described in ASTM D3985. The model OX-TRAN 100A of (Mocon corporation, USA) was used and the diffusion cell area was 100 cm².

1-15. (canceled)

16. A polyolefin construction comprising
a polyolefin layer (PO) which comprises ethylene-propylene random copolymers having a comonomer content of 1.5 to 6% by weight and a melt flow rate (MFR; 230° C./2.16 kg; ISO 1133) of 1 to 100 g/10 min,
a barrier layer which forms a barrier against O₂, CO₂ and liquid or volatile hydrocarbons for the polyolefin layer, and
a compatibiliser for the PO and the barrier layer which comprises maleic anhydride grafted polypropylene or polyethylene homo- or copolymers and/or maleic anhydride grafted and/or hydrogenated styrene block copolymers having a melt flow rate (230° C./2.16 kg; ISO 1133) of 1 to 100 g/10 min and wherein the anhydride content of maleic anhydride grafted polymers is 0.1 to 10 wt %, and which enables the PO and barrier layer to adhere together,
whereby the barrier layer comprises the compatibiliser.

17. A PO construction according to claim 16 wherein the barrier layer comprises a polyamide, polyvinyl alcohol copolymers or ethylene vinyl alcohol copolymers or blends thereof.

18. A PO construction according to claim 16 wherein the ethylene-propylene random copolymers of the PO layer have a melt flow rate (MFR; 230° C./2.16 kg; ISO 1133) of 2 to 50 g/10 min.

19. A PO construction according to claim 16 wherein the compatibiliser comprises maleic anhydride grafted polypropylene or polyethylene homo- or copolymers and/or maleic anhydride grafted and/or hydrogenated styrene block copolymers having a melt flow rate (230° C./2.16 kg; ISO 1133) of 2 to 50 g/10 min and wherein the anhydride content of the maleic anhydride grafted polymers is 0.1 to 10 wt %.

20. A PO construction according to claim 16, wherein the compatibiliser is blended with the barrier layer forming polymer so that the total weight of the compatibiliser lies in the range of 0.1-20%, preferably 0, 5-15%, and preferably is at the most 10% of the barrier layer forming polymer.

21. A PO construction according to claim 61, exhibiting an adhesion force between the barrier layer and the PO layer of >3N up to 20 N (ASTM D 1876-01).

22. A blend mixture for forming a barrier layer comprising a barrier layer forming polymer which is selected from the group consisting of polyamide, polyvinyl alcohol copolymers or ethylene vinyl alcohol copolymers or blends thereof and 0.1-20 wt % of a compatibiliser, based on the amount of barrier forming polymer, wherein the compatibiliser comprises maleic anhydride grafted polypropylene or polyethylene homo- or copolymers and/or maleic anhydride grafted and/or hydrogenated styrene block copolymers having a melt flow rate (230° C./2.16 kg; ISO 1133) of 1 to 100 g/10 min and wherein the anhydride content of maleic anhydride grafted polymers is 0.1 to 10 wt %.

23. A blended mixture according to claim 22 comprising EVOH as barrier layer forming polymer and a compatibiliser selected from maleic anhydride grafted polypropylene homo-copolymers having a melt flow rate (MFR; 230° C./2.16 kg) of 2 to 50 g/10 min and an anhydride content of 0.1 to 10, preferably 0.2 to 8 wt %, non-grafted, hydrogenated or maleic anhydride grafted styrene-ethylene-butene-styrene terpolymers.

24. Process for the formation of a PO construction according to claim 16 or an article comprising the PO construction according to claim 16 comprising cast film extrusion techniques followed by uni- or biaxially stretching techniques or injection and blow moulding techniques, preferably injection stretch blow moulding.

25. Process for the formation of a PO construction or an article according to claim 24 comprising:
I. mixing a compatibiliser which comprises maleic anhydride grafted polypropylene or polyethylene homo- or copolymers and/or maleic anhydride grafted and/or hydrogenated styrene block copolymers having a melt flow rate (230° C./2.16 kg; ISO 1133) of 1 to 100 g/10 min and wherein the anhydride content of maleic anhydride grafted is 0.1 to 10 wt %
with a barrier layer forming polymer which is selected from the group consisting of polyamide, polyvinyl alcohol copolymers or ethylene vinyl alcohol copolymers or blends thereof
and extruding the resulting mixture;
II. co-injecting the extrudate from step (I) and a PO layer forming polymer, to form a 2- or a 3-layer pre-form, in which 3-layer pre-form the barrier layer forms a core layer and the PO layers form the outer layers;
III. allowing the pre-form to cool;
IV. reheating the pre-form to a temperature in the range 90 to 160 deg. C.; and
V. stretching and blowing the pre-from to form article
or
VI. stretching and blowing the pre-form to form an article without allowing the pre-form to cool and without reheating.

26. At least two layer article comprising
I. a first layer comprising ethylene-propylene random copolymers having a comonomer content of 1.5 to 6% by weight and a melt flow rate (MFR; 230° C./2.16 kg; ISO 1133) of 1 to 100 g/10 min,
II. a second layer comprising an bather layer forming polymer which is selected from the group consisting of polyamide, polyvinyl alcohol copolymers or ethylene vinyl alcohol copolymers or blends thereof
blended with a compatibiliser which comprises maleic anhydride grafted polypropylene or polyethylene homo- or copolymers and/or maleic anhydride grafted and/or hydrogenated styrene block copolymers having a melt flow rate (230° C./2.16 kg; ISO 1133) of 1 to 100 g/10 min and wherein the anhydride content of maleic anhydride grafted polymers is 0.1 to 10 wt %
and
III. optionally a third layer comprising a random polypropylene copolymer.
